(19) United States
(12) Patent Application Publication
(10) Pub. No.: US 2006/0109568 A1
(43) Pub. Date: May 25, 2006

(54) Camera lens

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/283,284

(22) Filed: Nov. 17, 2005

(30) Foreign Application Priority Data
Nov. 19, 2004 (TW) 93218565

(51) Int. Cl. G02B 13/18

(52) U.S. Cl. 359/708

(57) ABSTRACT

A camera lens (2, 3) for a portable electronic device includes an aspheric lens (20, 30) and at least one phase grating (21, 31). The aspheric lens includes a first optical surface (201) and a second optical surface (202). At least one of the two optical surfaces is an aspheric surface and at least one phase grating is formed with the aspheric lens in a whole. The phase grating is formed at one of the first optical surface and the second optical surface of the aspheric lens. The camera lens comprises a single aspheric lens having a phase grating. Because the camera lens does not comprise any spherical lens, spherical aberrations can be eliminated, and the volume of the camera lens can be reduced.

### FIELD OF THE INVENTION

The present invention generally relates to camera lenses for portable electronic devices such as digital cameras, and more particularly to a camera lens that has a lens element with an aspheric surface.

### GENERAL BACKGROUND

Digital cameras utilizing high-resolution electronic imaging sensors typically require high resolution optical components including lenses. These camera lenses should be very compact, so that they can be incorporated into other electronic devices such as palm-sized computers, cellular telephones, and the like.

A lens for a digital camera generally has several individual lens elements. The lens elements are typically spherical, and usually create spherical aberration. Chromatic aberration, coma, distortion, and field curvature are also common optical aberrations that occur in the imaging process of a typical lens. A large number of lens elements are generally required in order to balance the inherent optical aberrations. Camera lenses having a large number of lens elements tend to be large, heavy, and expensive to manufacture. The large number of lens elements increases material costs, and increases the cost of assembling and mounting the lens elements into the barrel of a camera lens.

Further, conventional camera lenses commonly use one or more aspheric lens elements, each of which has one or two aspheric surfaces. The aspheric lens elements are made of plastic or glass. Aspheric glass lens elements may be produced through glass molding methods, but the cost of this kind of method is higher compared to methods of manufacturing aspheric plastic lens elements. In addition, aspheric glass lens elements generally have poor resistance to strong impact, and are easily damaged. Furthermore, glass lens elements are heavier than plastic lens elements, and militate against the trend toward lightweight digital cameras. In comparison, aspheric plastic lens elements may be easily produced by plastic injection molding, and are relatively inexpensive. A plastic lens element is light in weight, and does not easily break.

A typical camera lens having only spherical lens elements is disclosed in U.S. Pat. No. 6,282,033. The camera lens includes four lens elements. A first lens element is biconvex, a second lens element is biconcave, a third lens element is a meniscus, and a fourth lens element is biconvex. All of the lens elements are made of glass, and all their surfaces are spherical. Such spherical glass lens elements are relatively easy to make. However, the overall weight of the lens is unduly great. In addition, the lens elements are easily damaged if they are subjected to shock, such as when a digital camera is dropped to the ground. Furthermore, the spherical lens elements are apt to produce spherical aberration, thereby diminishing the image quality.

A typical camera lens having both spherical lens elements and aspheric lens elements is disclosed in U.S. Pat. No. 6,441,971. The camera lens includes three lens elements. A first lens element is a made of glass material, and is a spherical meniscus. A second lens element and a third lens element are aspheric, and are made of plastic material. The combination of a glass spherical lens element and plastic aspheric lens elements can decrease the overall weight of the lens. However, the impact resistance of the lens is still rather weak, and the lens may be easily damaged if the corresponding digital camera is dropped to the ground.

Accordingly, what is needed is a lens for a digital camera which is light, inexpensive, and has strong impact resistance and good quality imaging.

### SUMMARY

A camera lens of a preferred embodiment comprises an aspheric lens and at least one phase grating. The aspheric lens includes a first optical surface and a second optical surface. At least one of the two optical surfaces is an aspheric surface and at least one phase grating is formed with the aspheric lens in a whole. The phase grating is formed at one of the first optical surface and the second optical surface of the aspheric lens.

The camera lens comprises a single aspheric lens having a phase grating. Because the camera lens does not comprise any spherical lens, spherical aberrations can be eliminated, and the volume of the camera lens can be reduced. In addition, the camera lens does not need a conventional barrel, and can instead be directly mounted in a portable electronic device such as a digital camera. Further, because the camera lens is made by plastic injection molding, it can be readily mass manufactured. Therefore, the cost of the camera lens can be reduced while providing high quality.

As a further improvement of the present invention, a film coating is plated on surfaces of the spherical lenses for improving the image quality and for protecting the camera lens from physical damage.

Other advantages and novel features will become more apparent from the following detailed description when taken in conjunction with the accompanying drawings, in which:

### BRIEF DESCRIPTION OF THE DRAWINGS

FIG. 1 is a schematic, side cross-sectional view of a camera lens for a digital camera according to a first preferred embodiment of the present invention; and

FIG. 2 is a schematic, side cross-sectional view of a camera lens for a digital camera according to a second preferred embodiment of the present invention.

### DETAILED DESCRIPTION OF PREFERRED EMBODIMENTS

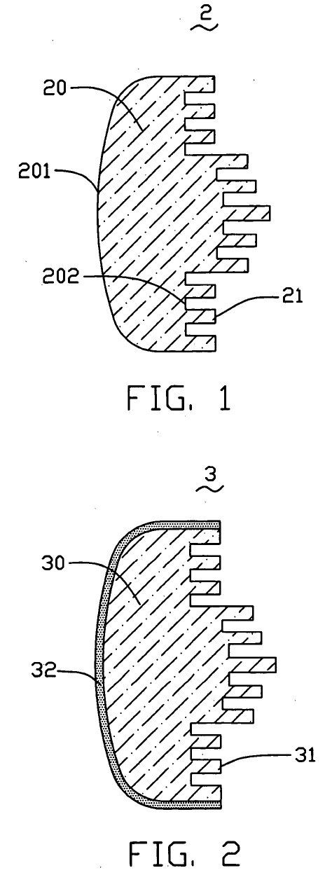

Referring to FIG. 1, a camera lens 2 of a first preferred embodiment includes an aspheric lens 20 and at least one phase grating 21. The aspheric lens 20 is made of plastic material such as PMMA (polymethyl methacrylate) or PC (polycarbonate), and includes a first optical surface 201 and a second optical surface 202. At least one of the first optical surface 201 and the second optical surface 202 is an aspheric surface. The phase grating 21 is a binary phase grating formed at one of the first optical surface 201 and the second optical surface 202 of the aspheric lens 20. Preferably, the phase grating 21 is formed at the second optical surface 202.

The method of manufacturing the camera lens 2 includes the following steps: firstly, designing the shape and the structure of the aspheric lens 20 and the phase grating 21; secondly, designing a mold (not shown) according to the shape and the structure of the aspheric lens 20 and the phase grating 21; and finally, injecting a plastic material into the mold to form the camera lens 2. Thus, the camera lens 2 can be mass manufactured by a method of plastic injection molding. The mold can be made of tooling steel, which is plated with Ni (nickel).

Referring to FIG. 2, a camera lens 3 of a second preferred embodiment includes an aspheric lens 30 and at least one phase grating 31. The shape, structure and material of the aspheric lens 30 are substantially the same as those of the aspheric lens 20, except that a film coating 32 is plated on surfaces of the spherical lens 30 including a first optical surface thereof. The film coating 32 is for improving the image quality provided by the camera lens 3, and for protecting the camera lens 3 from physical damage. The film coating 32 comprises layers of material having a high refractive index, and layers of material having a low refractive index. Typically, the high refractive index layers and low refractive index layers are stacked one on another to achieve a desired optical effect. For example, the film coating 32 can be an antireflective film or an infrared cut film. The high refractive index material can be Ta₂O₅, TaO₂, TaO₃ or Ta₃O₅, and the low refractive index material can be SiO₂ or Al₂O₃.

In summary, the camera lens 2, 3 comprises a single aspheric lens 20, 30 having a phase grating 21, 31. Because the camera lens 2, 3 does not comprise any spherical lens, spherical aberrations can be eliminated, and the volume of the camera lens 2, 3 can be reduced. In addition, the camera lens 2, 3 does not need a conventional barrel, and can instead be directly mounted in a portable electronic device such as a digital camera. Further, because the camera lens 2, 3 is made by plastic injection molding, it can be readily mass manufactured. Therefore, the cost of the camera lens 2, 3 can be reduced while providing high quality. Besides, the lens 2, 3 is capable of be manufactured to include two separate parts, one is an aspheric lens without other optical elements formed thereon, and the other is a phase grating element spaced from the aspheric lens.

While certain specific relationships, materials and other parameters have been detailed in the above description of preferred embodiments, the described embodiments can be varied, where suitable, within the principles of the present invention. It should be understood that the preferred embodiments have been presented by way of example only and not by way of limitation. Thus the breadth and scope of the present invention should not be limited by the above-described exemplary embodiments, but should be defined according to the following claims and their equivalents.

I claim:

1. A camera lens for a portable electronic device, comprising:
an aspheric lens comprising a first optical surface and a second optical surface, at least one of which is an aspheric surface; and
at least one phase grating formed at one of the first optical surface and the second optical surface of the aspheric lens.

2. The camera lens as claimed in claim 1, wherein the aspheric lens is made of plastic.

3. The camera lens as claimed in claim 2, wherein the plastic is PMMA (polymethyl methacrylate).

4. The camera lens as claimed in claim 2, wherein the plastic is PC (polycarbonate).

5. The camera lens as claimed in claim 1, wherein a film coating is provided on one of the first optical surface and the second optical surface that does not have the phase grating.

6. The camera lens as claimed in claim 5, wherein the film coating is an antireflective film.

7. The camera lens as claimed in claim 5, wherein the film coating is an infrared cut film.

8. The camera lens as claimed in claim 1, wherein the lens is plastic injection molded.

9. The camera lens as claimed in claim 1, wherein the phase grating is a binary phase grating.

10. A lens assembly for an electronic device, comprising:
an aspheric lens comprising at least one aspheric optical surface formed thereon; and
a phase grating arranged in a same optical path with said aspheric lens and spaced from said at least one aspheric optical surface of said aspheric lens.

11. The lens assembly as claimed in claim 10, wherein said aspheric lens is made from plastic material.

12. The lens assembly as claimed in claim 10, wherein said phase grating is a binary phase grating.

13. The lens assembly as claimed in claim 10, wherein said phase grating is integrally formed with said aspheric lens.

14. A method to manufacture a lens assembly, comprising the steps of:
defining required optical characteristics of an aspheric optical surface and a phase grating respectively;
forming an aspheric lens bearing said aspheric optical surface at a side thereof according to said optical characteristics of said aspheric optical surface; and
forming said phase grating aligned with said aspheric optical surface and spaced therefrom according to said optical characteristics of said phase grating so as to acquire said lens assembly.
